(19) United States
(12) Patent Application Publication
(10) Pub. No.: US 2023/0334990 A1
(43) Pub. Date: Oct. 19, 2023

(54) COMMUNICATION METHOD AND COMMUNICATION DEVICE BASED ON 5G AND WI-FI 6

(71) Applicant: MICRONET UNION TECHNOLOGY (CHENGDU) CO., LTD., CHENGDU (CN)

(72) Inventors: QIMING LIANG, CHENGDU (CN); LEILEI XI, CHENGDU (CN); XINYUN GUAN, CHENGDU (CN)

(21) Appl. No.: 18/337,045

(22) Filed: Jun. 19, 2023

Related U.S. Application Data
(63) Continuation of application No. PCT/CN2021/135054, filed on Dec. 2, 2021.

(30) Foreign Application Priority Data
Dec. 29, 2020 (CN) 202011591321.5

(51) Int. Cl. G08G 5/00; H04W 52/02; H04W 64/00; H04B 7/06; G07C 5/00

(52) U.S. Cl. CPC G08G 5/0013; H04W 52/0261; H04W 64/006; H04B 7/063; G07C 5/008; H04W 84/06

(57) ABSTRACT

A communication method and a communication device based on 5G and Wi-Fi 6 are provided. The communication method includes broadcasting signaling messages comprising a physical device identification of a target aircraft by a 5G signal base station; obtaining a feedback message of the target aircraft; determining an antenna array unit of a plurality of antenna array units of required to communicate with the target aircraft based on the feedback message; transmitting communication information to the target aircraft by the antenna array unit; wherein the communication information comprises control information of a plurality of aircraft in a target aircraft group; receiving the communication information by the target aircraft; and respectively transmitting the control information in the communication information to a corresponding aircraft in the target aircraft group by Wi-Fi 6.

### CROSS-REFERENCE TO RELATED APPLICATIONS

This application claims priority to Chinese Patent Application No. 202011591321.5 filed on Dec. 29, 2020, with a title of “a communication method and a communication device based on 5G and Wi-Fi 6”, the contents of which are incorporated by reference herein.

### FIELD

The present disclosure generally relates to a field of mobile communication, and particularly to a communication method and a communication device based on 5G and Wi-Fi 6.

### BACKGROUND

With rapid development of logistics industry, a related technology of using aircraft to transport express items has begun to take shape.

On one hand, due to the flight in the air, energy consumed by the aircraft is greater than that of machine equipment traveling on the ground. Therefore, when using the aircraft to transport the express items, it is necessary to consider power consumption of the aircraft.

On the other hand, the aircraft flying in the air need to receive a remote control signal, and only under control of the control signal, the express items can be transported safely and quickly.

### SUMMARY

In a first aspect, the present disclosure provides a communication method based on 5G and Wi-Fi 6, the communication method includes:
broadcasting signaling messages including a physical device identification of a target aircraft by a 5G signal base station;
obtaining a feedback message of the target aircraft;
determining an antenna array unit, of a plurality of antenna array units, required to communicate with the target aircraft based on the feedback message;
transmitting communication information to the target aircraft by the antenna array unit; where the communication information includes control information of a plurality of aircraft in a target aircraft group;
receiving the communication information by the target aircraft; and
respectively transmitting the control information in the communication information to a corresponding aircraft in the target aircraft group by Wi-Fi 6.

In some embodiments, the communication method further includes:
determining the target aircraft located within a signal range of the 5G signal base station according to location information of each of the plurality of aircraft by a server; and
transmitting the physical device identification of the target aircraft to the 5G signal base station.

A step of broadcasting the signaling messages including the physical device identification of the target aircraft by the 5G signal base station includes:
broadcasting the signaling messages in various directions by the 5G signal base station by via the plurality of antenna array units in various directions; where each of the signaling messages includes an antenna array unit identification of a corresponding antenna array unit broadcasting a corresponding signaling message.

In some embodiments, the communication method further includes:
determining a specific antenna array unit identification in a received signaling message by the target aircraft; and
generating the feedback message including the specific antenna array unit identification.

A step of determining the antenna array unit, of the plurality of antenna array units, required to communicate with the target aircraft based on the feedback message includes:
determining the antenna array unit corresponding to the specific antenna array unit identification as the antenna array unit required to communicate with the target aircraft.

In some embodiments, the communication method further includes:
obtaining remaining battery information of each of the plurality of aircraft in the target aircraft group;
obtaining remaining flight route information of each of the plurality of aircraft in the target aircraft group;
calculating information of battery energy to be consumed by each of the plurality of aircraft based on the remaining flight route information of each of the plurality of aircraft; and
determining the target aircraft according to the remaining battery information and the information of the battery energy to be consumed by each of the plurality of aircraft.

In some embodiments, a step of calculating the information of the battery energy to be consumed by each of the plurality of aircraft based on the remaining flight route information includes:
determining a flight direction and a flight speed of each of the plurality of aircraft;
determining a windage pressure of each of the plurality of aircraft in the flight direction;
calculating energy required by each of the plurality of aircraft to complete the remaining flight route, according to the windage pressure and the flight speed; and
obtaining the information of the battery energy to be consumed based on the energy required by each of the plurality of aircraft.

In some embodiments, a step of calculating the energy required by each of the plurality of aircraft to complete the remaining flight route includes:
calculating power P₀ required by each of the plurality of aircraft to complete the remaining flight route by a formula of F₁*v1+F₂*sin α*v2+P;
obtaining energy W required by each of the plurality of aircraft according to a time t required for each of the plurality of aircraft to complete the remaining flight route of each of the plurality of aircraft.

Where v1 is the flight speed of each of the plurality of aircraft, and F₁ is a forward direction resistance of each of the plurality of aircraft; v2 is a wind speed, and F₂ is a lateral windward resistance of each of the plurality of aircraft; α is an angle between an opposite direction of forward motion of each of the plurality of aircraft and a wind direction, and P is hovering power of each of the plurality of aircraft.

In some embodiments, a step of obtaining the information of the battery energy to be consumed based on the energy required by each of the plurality of aircraft includes:
calculating the battery energy to be consumed by a formula of W/ε, where W is the energy required by each of the plurality of aircraft to complete the remaining flight route, and ε is a battery energy conversion coefficient of each of the plurality of aircraft.

In some embodiments, a step of determining the target aircraft according to the remaining battery information and the information of the battery energy to be consumed by each of the plurality of aircraft includes:
determining one of the plurality of aircraft whose remaining battery is greater than the battery energy to be consumed as the target aircraft.

In some embodiments, a step of determining the target aircraft according to the remaining battery information of each of the plurality of aircraft and the information as to the battery energy to be consumed includes:
when the remaining battery of each of the plurality of aircraft is greater than the battery energy to be consumed, determining the aircraft with a highest remaining battery as the target aircraft.

The target aircraft includes a solar panel. The communication method further includes:
obtaining a location coordinate of the target aircraft;
obtaining a standard time of a time zone corresponding to the location coordinate of the target aircraft;
determining an optimal energy absorption azimuth angle of the target aircraft according to the standard time and the location coordinate of the target aircraft; when an angle between a light energy absorption surface of the solar panel and a horizontal plane is equal to the optimal energy absorption azimuth angle, the light energy absorption efficiency of the solar panel is highest;
determining a target azimuth angle based on the optimal energy-absorbing azimuth angle of the target aircraft; and
adjusting the angle between the light energy absorption surface of the solar panel and the horizontal plane to the target azimuth angle.

In a second aspect, the present disclosure provides a communication device based on 5G and Wi-Fi 6. The electronic device includes at least one processor and a memory communicated with the at least one processor. The memory stores instructions are executed by the at least one processor to cause the at least one processor to execute the communication method.

In some embodiments, the present disclosure provides a solution that combines a 5G communication technology with a Wi-Fi 6 communication technology, on one hand, the speed and quality of communication with the plurality of aircraft is ensured, on the other hand, the power consumption of the plurality of aircraft is reduced.

### BRIEF DESCRIPTION OF THE DRAWINGS

The accompanying drawings, which are incorporated in and constitute a part of this specification, illustrate the embodiments of the present disclosure, and together with the specification to explain the principles of the present disclosure.

For describing the technical solutions of the present disclosure clearly, the following will briefly introduce the accompanying drawings used in the present disclosure. Obviously, for those of ordinary skill in the art, on the premise of not paying creative efforts, additional drawings can be derived from these drawings.

FIG. 1 is a schematic diagram of a communication scenario of aircraft according to one embodiment of the present disclosure.

FIG. 2 is a flowchart of a communication method based on 5G and Wi-Fi 6 according to one embodiment of the present disclosure.

FIG. 3 is a free-body diagram of one of a plurality of aircraft according to one embodiment of the present disclosure;

FIG. 4 is a schematic diagram showing resolution of a wind force in FIG. 3 according to one embodiment of the present disclosure; and

FIG. 5 is a structural schematic diagram of a communication device according to one embodiment of the present disclosure.

### DETAILED DESCRIPTION

In order to make the purpose, technical solutions, and advantages of the embodiments of the present disclosure clear, the technical solutions in the embodiments of the present disclosure will be clearly and completely described below, in conjunction with the drawings in the embodiments of the present disclosure. Obviously, the described embodiments are some of the embodiments of the present disclosure, not all of the embodiments. Based on the embodiments in the present disclosure, all other embodiments obtained by those of ordinary skill in the art without making creative efforts fall within the protection scope of the present disclosure.

With development of Internet, the fifth generation mobile communication technology (i.e., the 5^{th} generation mobile network or the 5^{th} generation wireless systems, abbreviated as 5G or 5D technology) is the latest generation of cellular mobile communication technology, and it is also an extension following 4G (e.g., LTE-A, WiMax), 3G (e.g., UMTS, LTE), and 2G (GSM) system. Performance goals of 5G includes high data rate, reduced latency, energy saving, cost reduction, increased system capacity, and large-scale device connectivity.

At the same time, a technical solution of the present disclosure also adopts a communication mode of Wi-Fi 6 to realize the communication between aircraft.

Wi-Fi 6 (formerly known as 802.11.ax) is the sixth generation of wireless network technology and is a name of the Wi-Fi standard. Wi-Fi 6 is a wireless local area network technology created by the Wi-Fi Alliance based on the IEEE 802.11 standard. Wi-Fi 6 mainly adopts technologies such as Orthogonal Frequency Division Multiple Access (OFDMA), Multi-User Multiple-Input Multiple-Output (MU-MIMO) etc. The MU-MIMO technology allows a router to communicate with multiple devices simultaneously instead of sequentially. For example, the MU-MIMO technology allows the router to communicate with four devices simultaneously, and Wi-Fi 6 allows the router to communicate with eight devices.

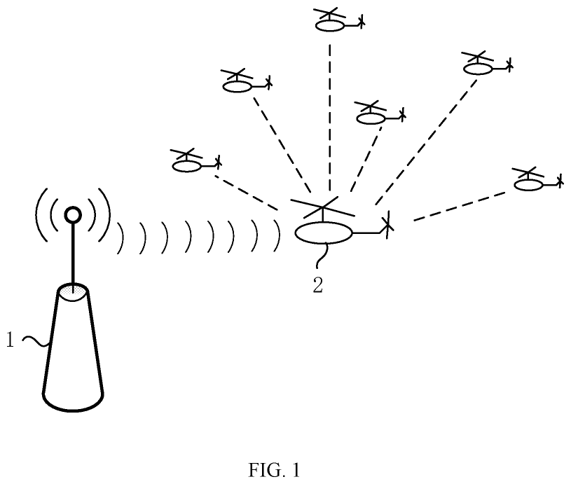

FIG. 1 is a schematic diagram of a communication scenario of aircraft according to one embodiment of the present disclosure.

As shown in FIG. 1, a signal base station 1 is a base station supporting a 5G signal transceiving function (i.e., a 5G signal base station). A target aircraft 2 is a logistics-specific aircraft configured to transport items such as express deliveries. In an adjacent area of a flight space of the target aircraft 2, there are also other aircraft. The signal base station 1 communicates with the target aircraft 2 through 5G signals. After the target aircraft 2 receives information from the signal base station 1, the target aircraft 2 communicates with the other aircraft in the adjacent area by Wi-Fi 6. Therefore, on one hand, the information is directed to the target aircraft 2 by the 5G signals, and a rate for transmitting information is relatively high. Since an information transmission rate of the Wi-Fi 6 is relatively high, and power consumption of the Wi-Fi 6 is relatively low in a communication mode of the wireless local area network, communication between the target aircraft 2 and the other aircraft in the adjacent area has high efficiency and low power consumption. In addition, the other aircraft in the adjacent area of the target aircraft 2 do not need to communicate with the signal base station through 5G, but only need to communicate with the target aircraft 2 through Wi-Fi 6, which further reduces the power consumption of the other aircraft.

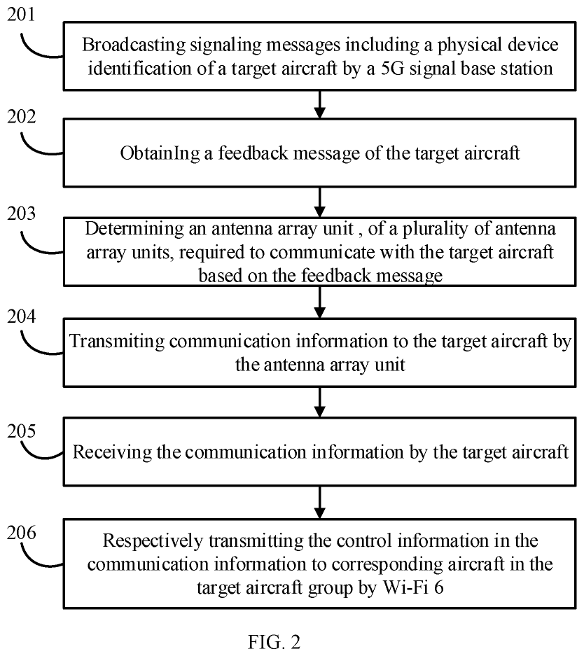

FIG. 2 is a flowchart of a communication method based on 5G and Wi-Fi 6 according to one embodiment of the present disclosure. As shown in FIG. 2, the communication method includes the following steps.

Step 201: broadcasting signaling messages including a physical device identification of the target aircraft by the 5G signal base station;

Step 202: obtaining a feedback message of the target aircraft;

Step 203: determining an antenna array unit, of a plurality of antenna array units, required to communicate with the target aircraft based on the feedback message;

Step 204: transmitting communication information to the target aircraft by the antenna array unit; the communication information includes control information of a plurality of aircraft in a target aircraft group;

Step 205: receiving the communication information by the target aircraft; and

Step 206: respectively transmitting the control information in the communication information to corresponding aircraft in the target aircraft group by Wi-Fi 6.

The broadcast may be a broadcast directed towards various directions. Each of the plurality of antenna array units of the 5G signal base station is integrated with a plurality of antenna units. The plurality of antenna units broadcast signals in various directions. The signaling messages refer to messages configured to control a communication process of the target aircraft. The physical device identification refers to an identification used to distinguish the target aircraft from the other aircraft (i.e., the other aircraft in the target aircraft group except for the target aircraft). The physical device identification may be a Media Access Control (MAC) address of a device such as a processor on the target aircraft, or other identifications, as long as the target aircraft is able to be distinguished.

Since the target aircraft is the logistics-specific aircraft configured to transport items, which does not need to fly at a high altitude, the target aircraft flies at a low altitude and be close to the 5G signal base station and receives the one of the signaling messages transmitted by the 5G signal base station. The target aircraft transmits the feedback message after receiving the one of the signaling messages transmitted by the 5G signal base station. The feedback message includes an identification of the antenna array unit.

Since the feedback message includes the identification of the antenna array unit, it is determined that which antenna array unit of the plurality of antenna array units is communicated with the target aircraft according to the feedback message.

After the antenna array unit is determined, the antenna array unit is configured to transmit the communication information to the target aircraft.

The control information in the communication information controls flight processes of the plurality of aircraft in the target aircraft group. The target aircraft group includes the target aircraft and the other aircraft in the adjacent area of the target aircraft. The control information may be control information on a flight speed, a flight altitude, or a flight direction of a certain aircraft.

The target aircraft acts as a router in the target aircraft group. The target aircraft may set itself as a Wi-Fi hotspot supporting a Wi-Fi 6 communication mode. After the target aircraft receives the communication information, the target aircraft transmits the communication information to the corresponding aircraft respectively by the Wi-Fi 6 communication mode.

In some embodiments, each control information in the communication information includes an aircraft equipment identification corresponding to a corresponding aircraft. Each aircraft equipment identification is included in the communication information in a predetermined communication protocol format. After the target aircraft receives the communication information, the target aircraft identifies each control information for the corresponding aircraft in the target aircraft group according to the predetermined communication protocol and each corresponding aircraft equipment identification. Then, the target aircraft transmits the control information of each of the plurality of aircraft to the corresponding aircraft through the predetermined communication protocol with the aircraft by means of Wi-Fi 6.

In some embodiments, before the step of broadcasting the signaling messages including the physical device identification of the target aircraft by the 5G signal base station, the communication method further includes following steps:
determining the target aircraft located within a signal range of the 5G signal base station according to location information of each of the plurality of aircraft by a server; and
transmitting the physical device identification of the target aircraft to the 5G signal base station.

The step of broadcasting the signaling messages including the physical device identification of the target aircraft by the 5G signal base station includes:
broadcasting the signaling messages in various directions by the 5G signal base station via the plurality of antenna array units in various directions; each of the signaling messages includes an antenna array unit identification of a corresponding antenna array unit broadcasting a corresponding signaling message.

In some embodiments, the server may be a server in the communication network responsible for providing services for the 5G signal base station. The server is able to obtain the location information of each of the plurality of aircraft. The location information of each of the plurality of aircraft may represent by a two-dimensional plane coordinate or a three-dimensional space coordinate. The signal range of the 5G signal base station may also be represented by another two-dimensional plane coordinate or another three-dimensional space coordinate. The location information of each of the plurality of aircraft and the signal range of the 5G signal base station are preferably represented by three-dimensional space coordinates. It should be noted that, since the target aircraft is configured as the aircraft for logistics transportation, and transported items are generally scattered and small, therefore, the flight altitude of the target aircraft is low. Thus, the target aircraft is able to communicate with the 5G signal base station through the 5G signals.

In some cases, the target aircraft only receive the one of the signaling messages in one direction. After the target aircraft receives the one of the signaling messages, the communication method further includes:
determining a specific antenna array unit identification included in the received signaling message by the target aircraft; and
generating the feedback message including the specific antenna array unit identification.

The step of determining the antenna array unit, of the plurality of antenna array units, required to communicate with the target aircraft based on the feedback message includes:
determining the antenna array unit corresponding to the specific antenna array unit identification as the antenna array unit required to communicate with the target aircraft. and
using the determined antenna array unit (i.e., the antenna array unit in one direction communicated with the target aircraft) required to communicate with the target aircraft to communicate with the target aircraft, which also saves communication power and communication resources of the 5G signal base station).

In some embodiments, before the step of broadcasting the signaling messages including the physical device identification of the target aircraft by the 5G signal base station, the communication method further includes:
obtaining remaining battery information of each of the plurality of aircraft in the target aircraft group;
obtaining remaining flight route information of each of the plurality of aircraft in the target aircraft group;
calculating information of battery energy to be consumed by each of the plurality of aircraft based on the remaining flight route information of each of the plurality of aircraft; and
determining the target aircraft according to the remaining battery information of each of the plurality of aircraft and the information of the battery energy to be consumed by each of the plurality of aircraft.

In some embodiments, the remaining battery information represents a flight power output by each of the plurality of aircraft according to remaining battery thereof. Alternatively, according to the remaining battery information, the flight power output by each of the plurality of aircraft is calculated based on the remaining battery of each of the plurality of aircraft.

There are many ways to determine the target aircraft, but one preferred principle is that the remaining battery of the target aircraft is greater than the battery energy to be consumed by the target aircraft.

As the target aircraft, it actually serves as the router for the other aircraft in the target aircraft group. Since the target aircraft should be served as the router, the target aircraft consumes more power. Therefore, when determining the target aircraft, one of the plurality of .aircraft with highest remaining battery is selected first.

In some embodiments, a step of calculating the information of the battery energy to be consumed by each of the plurality of aircraft based on the remaining flight route information of each of the plurality of aircraft includes:
determining a flight direction and a flight speed of each of the plurality of aircraft;
determining a windage pressure of each of the plurality of aircraft in the flight direction thereof;
calculating energy required by each of the plurality of aircraft to complete a remaining flight route, according to the windage pressure and the flight speed of each of the plurality of aircraft; and
obtaining the information of the battery energy to be consumed by each of the plurality of aircraft based on the energy required by each of the plurality of aircraft.

In some embodiments, a step of calculating the energy required by each of the plurality of aircraft to complete the remaining flight route, according to the windage pressure and the flight speed of each of the plurality of aircraft; includes:

calculating power P₀ required by each of the plurality of aircraft to complete the remaining flight route by a formula of F₁*v1+F₂*sin α*v2+P (formula (1)).

In the formula (1), v1 is the flight speed of each of the plurality of aircraft, and F₁ is a forward direction resistance of each of the plurality of aircraft; v2 is a wind speed, and F₂ is a lateral windward resistance of each of the plurality of aircraft; a is an angle between an opposite direction of forward motion of each of the plurality of aircraft and a wind direction, and, P is a hovering power of each of the plurality of aircraft.

It should be noted that, each of the plurality of aircraft includes a plurality of pressure sensors. The plurality of pressure sensors may be arranged on an outer side of each of the plurality of aircraft. In some embodiments, the plurality of pressure sensors of each of the plurality of aircraft include a first pressure sensor towards a forward direction of a corresponding aircraft, second pressure sensors towards a direction perpendicular to the forward direction of the corresponding aircraft (i.e., the second pressure sensors may be arranged on a left side and a right side of the corresponding aircraft), a third pressure sensor towards a rear direction of the corresponding aircraft. The plurality of pressure sensors each senses a wind force on a surface thereof. A conversion relationship between the wind force sensed by the plurality of pressure sensors and the wind force subjected to the corresponding aircraft under in corresponding directions is determined in advance, according to a surface area of each of the plurality of pressure sensors and a windward area of the corresponding aircraft in a corresponding direction. According to the conversion relationship, the force on the corresponding aircraft in the corresponding direction is calculated according to the wind force sensed by a corresponding pressure sensor of the plurality of pressure sensors.

The hovering power of each of the plurality of pressure sensors is determined according to a quantity of engine revolutions of a main propeller of each of the plurality of pressure sensors. In practical applications, the hovering power of each of the plurality of pressure sensors corresponding to different revolutions is recorded in a data sheet. The hovering power of each of the plurality of pressure sensors can be looked up in the data sheet according to the quantity of revolutions.

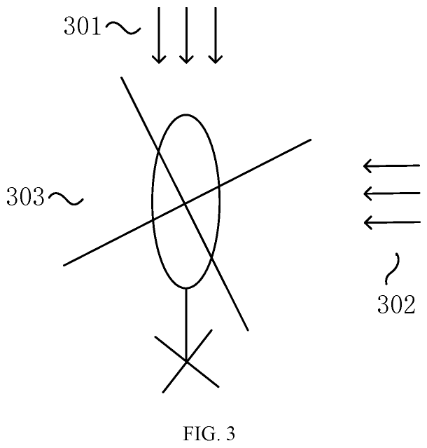

FIG. 3 is a schematic diagram showing forces each of the plurality of aircraft 303. Referring to FIG. 3, each of the plurality of aircraft 303 is subjected to resistance 301 from an opposite direction of a forward direction of each of the plurality of aircraft 303, and is also subjected to resistance 302 in a direction perpendicular to the forward direction (i.e., the right side of each of the plurality of aircraft 303 in FIG. 3).

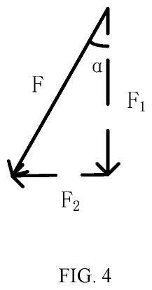

FIG. 4 is a schematic diagram showing resolution of the forces in FIG. 3. Referring to FIG. 4, a vector F represents an actual wind force, a vector F₁ represents the resistance 301 from an opposite direction of the forward direction of each of the plurality of aircraft 303, and a vector F₂ represents the resistance 302 from the direction perpendicular to the forward direction of each of the plurality of aircraft 303 (i.e., the right side of each of the plurality of aircraft 303 in FIG. 3, hereinafter also referred to as lateral resistance) . . . α is an angle between the vector F and the vector F₁. According to the formula for calculating the power of doing work, the power of doing work is a product of a force doing work and a velocity in a vector direction of the force.

In some embodiments, a direction of the wind speed and a direction of the wind force are the same, and a vector component of the wind speed v2 in a lateral direction is sin α*v2. During the flight of each of the plurality of aircraft 303, each of the plurality of aircraft 303 basically flies along the forward direction, and each of the plurality of aircraft 303 does not fly along the lateral direction. Since each of the plurality of aircraft 303 does not fly along the lateral direction, power prevents each of the plurality of aircraft 303 from flying along the lateral direction is F2*sin α*v2. Power of each of the plurality of aircraft 303 flying in the forward direction is F₁*v1. During the flight, each of the plurality of aircraft 303 flies in the air, each of the plurality of aircraft 303 has a hovering power P. In summary, the formula F₁*v1+F₂*sin α*v2+P is utilized to calculate the power P₀ required by each of the plurality of aircraft to complete the remaining flight route of each of the plurality of aircraft.

In some embodiments, after obtaining the power P₀ required to complete the remaining flight route of ach of the plurality of aircraft, the energy W required by each of the plurality of aircraft is obtained by multiplying a time t required by each of the plurality of aircraft with P₀ to complete the remaining flight route of each of the plurality of aircraft. It should also be noted that the above calculation process is a relatively simplified formula adopted to improve a calculation efficiency and a calculation speed. When the wind force changes greatly, an integration method can also be used to calculate the power at each time according to a predicted wind speed and a wind force at each time, and a plurality of power are integrated according to a time t, thereby obtaining more accurate energy values.

After the energy W required by each of the plurality of aircraft is obtained, the battery energy to be consumed by each of the plurality of aircraft is calculated by a formula of W/ε. W is the energy required by each of the plurality of aircraft to complete the remaining flight route of each of the plurality of aircraft, and ε is a battery energy conversion coefficient of each of the plurality of aircraft.

In some embodiments, it is assumed that the battery energy conversion coefficient of each of the plurality of aircraft is 80%, and the energy W required by each of the plurality of aircraft is 10 kWh, the battery energy to be consumed by each of the plurality of aircraft is calculated as 12.5 kWh according to the above formula.

It should be pointed out that, the above-mentioned determination method for the target aircraft is only one of a plurality of determination methods. In some embodiments, the main principle is to determine the one of the plurality of aircraft whose remaining battery is greater than the battery energy to be consumed as the target aircraft.

In some embodiments, if the remaining battery of each of the plurality of aircraft is greater than the battery energy to be consumed by each of the plurality of aircraft, the one of the plurality of aircraft with the highest remaining battery is determined as the target aircraft.

The target aircraft is optionally an aircraft provided with a solar panel. The communication method further includes following steps:
obtaining a location coordinate of the target aircraft;
obtaining a standard time of a time zone corresponding to the location coordinate of the target aircraft;
determining an optimal energy absorption azimuth angle according to the standard time and the location coordinate of the target aircraft; when an angle between a light energy absorption surface of the solar panel and a horizontal plane is equal to the optimal energy absorption azimuth angle, light energy absorption efficiency of the solar panel is the highest;
determining a target azimuth angle of the target aircraft based on the optimal energy-absorbing azimuth angle; and
adjusting the angle between the light energy absorption surface of the solar panel and the horizontal plane to the target azimuth angle.

In some embodiments, the optimal energy absorption azimuth angle may be an angle that makes the light energy absorption surface of the solar panel face an incident angle of sunlight. When the solar panel is adjusted to the optimal energy absorption azimuth angle, the incident angle of the sunlight is perpendicular to the light energy absorption surface of the solar panel.

The location coordinate of the target aircraft may be a three-dimensional space coordinate including altitude information. The time zone where the target aircraft is located is determined according to the location coordinate of the target aircraft. In the time zone, a location coordinate of the sun is determined according to a specific time. Further, the optimal energy absorption azimuth angle is determined according to the location coordinate of the sun and the location coordinate of the target aircraft.

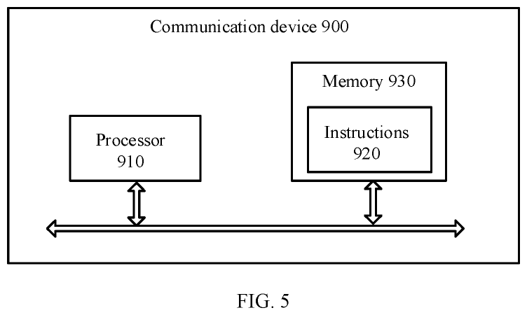

FIG. 5 is a structural schematic diagram of a communication device according to one embodiment of the present disclosure.

Referring to FIG. 5, the communication device 900 includes at least one processor 910; and a memory 930 communicated with the at least one processor 910.

The memory 930 stores instructions 920 executed by the at least one processor 910, and the instructions 920 are executed by the at least one processor 910 to cause the at least one processor to execute the communication method in the present disclosure. The communication method includes:
broadcasting the signaling messages including the physical device identification of the target aircraft by the 5G signal base station;
obtaining the feedback message of the target aircraft;
determining the antenna array unit, of a plurality of antenna array units, required to communicate with the target aircraft based on the feedback message;

Transmitting the communication information to the target aircraft by the antenna array unit; the communication information includes control information of the plurality of aircraft in the target aircraft group.

In some embodiments, the instructions 920 are executed by the at least one processor 910 to cause the at least one processor to perform the following steps:
obtaining remaining battery information of each of the plurality of aircraft in the target aircraft group;
obtaining remaining flight route information of each of the plurality of aircraft in the target aircraft group;
calculating information of the battery energy to be consumed by each of the plurality of aircraft based on the remaining flight route information; and
determining the target aircraft according to the remaining battery information and the information of battery energy to be consumed by each of the plurality of aircraft.

In some embodiments, the step of calculating the information of the battery energy to be consumed by each of the plurality of aircraft based on the remaining flight route information includes:
determining the flight direction and the flight speed of each of the plurality of aircraft;
determining the windage pressure of each of the plurality of aircraft in the flight direction;
calculating the energy required by each of the plurality of aircraft to complete the remaining flight route of each of the plurality of aircraft, according to the windage pressure and the flight speed; and
obtaining the information of the battery energy to be consumed by each of the plurality of aircraft based on the energy required by each of the plurality of aircraft.

In some embodiments, the step of calculating the energy required by each of the plurality of aircraft to complete the remaining flight route according to the windage pressure and the flight speed of each of the plurality of aircraft includes:
calculating the power P₀ required by each of the plurality of aircraft to complete the remaining flight route of each of the plurality of aircraft by the formula of F₁*v1+F₂*sin α*v2+P;
obtaining the energy W according to the time t required for each of the plurality of aircraft to complete the remaining flight route of each of the plurality of aircraft;
v1 is the flight speed of each of the plurality of aircraft, and F₁ is the forward direction resistance of each of the plurality of aircraft; v2 is the wind speed, and F₂ is the lateral windward resistance of each of the plurality of aircraft; α is the angle between an opposite direction of forward motion of each of the plurality of aircraft and the wind direction, and, P is the hovering power of each of the plurality of aircraft.

In some embodiments, the step of obtaining the information of the battery energy to be consumed by each of the plurality of aircraft based on the energy required by each of the plurality of aircraft includes:
calculating the battery energy to be consumed by each of the plurality of aircraft by the formula of W/ε, where W is the energy required by each of the plurality of aircraft to complete the remaining flight route of each of the plurality of aircraft, and ε is the battery energy conversion coefficient of each of the plurality of aircraft.

In some embodiments, the step of determining the target aircraft according to the remaining battery information of each of the plurality of aircraft and the information of the battery energy to be consumed by each of the plurality of aircraft includes:
determining the one of the plurality of aircraft whose remaining battery is greater than the battery energy to be consumed as the target aircraft.

In some embodiments, the step of determining the target aircraft according to the remaining battery information of each of the plurality of aircraft and the information of the battery energy to be consumed by each of the plurality of aircraft includes:
when the remaining battery of each of the plurality of aircraft is greater than the battery energy to be consumed, determining each of the plurality of aircraft with the highest remaining battery as the target aircraft.

The target aircraft includes the solar panel. The instructions 920 are executed by the at least one processor 910 to cause the at least one processor to perform the following steps:
obtaining the location coordinate of the target aircraft;
obtaining the standard time of the time zone corresponding to the location coordinate of the target aircraft;
determining the optimal energy absorption azimuth angle according to the standard time and the location coordinate of the target aircraft; when the angle between the light energy absorption surface of the solar panel and the horizontal plane is equal to the optimal energy absorption azimuth angle, the light energy absorption efficiency of the solar panel is the highest;
determining the target azimuth angle based on the optimal energy-absorbing azimuth angle; and
adjusting the angle between the light energy absorption surface of the solar panel and the horizontal plane to the target azimuth angle.

It should be noted that, relative terms such as “first” and “second” are only used to distinguish one entity or operation from another entity or operation, and do not necessarily require or imply any actual relationship or order exists between entities or operations. Furthermore, the term “includes”, “comprises” or any other variation thereof is intended to cover a non-exclusive inclusion such that a process, method, article, or apparatus comprising a set of elements includes not only those elements, but also includes other elements not expressly listed, or also include elements inherent in such a process, method, article, or device. Without further limitations, an element defined by the phrase “includes a . . . ” does not exclude the presence of additional identical elements in the process, method, article or apparatus including other same elements.

The above descriptions are only specific implementation manners of the present disclosure, so that those skilled in the art can understand or implement the present disclosure. Various modifications to these embodiments will be readily apparent to those skilled in the art, and the general principles defined herein may be implemented in other embodiments without departing from the spirit or scope of the present disclosure. Therefore, the present disclosure will not be limited to the embodiments shown herein, but is to conform to the widest scope consistent with the principles and novel features disclosed herein.

What is claimed is:

1. A communication method based on 5G and Wi-Fi 6, comprising:
broadcasting signaling messages comprising a physical device identification of a target aircraft by a 5G signal base station;
obtaining a feedback message of the target aircraft;
determining an antenna array unit, of a plurality of antenna array units, required to communicate with the target aircraft based on the feedback message;
transmitting communication information to the target aircraft by the antenna array unit; wherein the communication information comprises control information of a plurality of aircraft in a target aircraft group;
receiving the communication information by the target aircraft; and
respectively transmitting the control information in the communication information to a corresponding aircraft in the target aircraft group by Wi-Fi 6.

2. The communication method according to claim 1, wherein the communication method further comprises:
determining the target aircraft located within a signal range of the 5G signal base station according to location information of each of the plurality of aircraft by a server; and
transmitting the physical device identification of the target aircraft to the 5G signal base station;
wherein a step of broadcasting the signaling messages comprising the physical device identification of the target aircraft by the 5G signal base station comprises:
broadcasting the signaling messages in various directions by the 5G signal base station by via the plurality of antenna array units in various directions; wherein each of the signaling messages comprises an antenna array unit identification of a corresponding antenna array unit broadcasting a corresponding signaling message.

3. The communication method according to claim 2, wherein the communication method further comprises:
determining a specific antenna array unit identification in a received signaling message by the target aircraft; and
generating the feedback message comprising the specific antenna array unit identification;
wherein a step of determining the antenna array unit, of the plurality of antenna array units, required to communicate with the target aircraft based on the feedback message comprises:
determining the antenna array unit corresponding to the specific antenna array unit identification as the antenna array unit required to communicate with the target aircraft.

4. The communication method according to claim 1, wherein the communication method further comprises:
obtaining remaining battery information of each of the plurality of aircraft in the target aircraft group;
obtaining remaining flight route information of each of the plurality of aircraft in the target aircraft group;
calculating information of battery energy to be consumed by each of the plurality of aircraft based on the remaining flight route information of each of the plurality of aircraft; and
determining the target aircraft according to the remaining battery information and the information of the battery energy to be consumed by each of the plurality of aircraft.

5. The communication method according to claim 4, wherein a step of calculating the information of the battery energy to be consumed by each of the plurality of aircraft based on the remaining flight route information comprises:
determining a flight direction and a flight speed of each of the plurality of aircraft;
determining a windage pressure of each of the plurality of aircraft in the flight direction;
calculating energy required by each of the plurality of aircraft to complete the remaining flight route, according to the windage pressure and the flight speed; and
obtaining the information of the battery energy to be consumed based on the energy required by each of the plurality of aircraft.

6. The communication method according to claim 5, wherein a step of calculating the energy required by each of the plurality of aircraft to complete the remaining flight route comprises:
calculating power P₀ required by each of the plurality of aircraft to complete the remaining flight route by a formula of F₁*v1+F₂*sin α*v2+P;
obtaining the energy W required by each of the plurality of aircraft according to a time t required for each of the plurality of aircraft to complete the remaining flight route of each of the plurality of aircraft;
wherein v1 is the flight speed of each of the plurality of aircraft, and F₁ is a forward direction resistance of each of the plurality of aircraft; v2 is a wind speed, and F₂ is a lateral windward resistance of each of the plurality of aircraft; α is an angle between an opposite direction of forward motion of each of the plurality of aircraft and a wind direction, and P is hovering power of each of the plurality of aircraft.

7. The communication method according to claim 5, wherein a step of obtaining the information of the battery energy to be consumed based on the energy required by each of the plurality of aircraft comprises:
calculating the battery energy to be consumed by a formula of W/ε, wherein W is the energy required by each of the plurality of aircraft to complete the remaining flight route, and ε is a battery energy conversion coefficient of each of the plurality of aircraft.

8. The communication method according to claim 4, wherein a step of determining the target aircraft according to the remaining battery information and the information of the battery energy to be consumed by each of the plurality of aircraft comprises:
determining one of the plurality of aircraft whose remaining battery is greater than the battery energy to be consumed as the target aircraft.

9. The communication method according to claim 4, wherein a step of determining the target aircraft according to the remaining battery information of each of the plurality of aircraft and the information as to the battery energy to be consumed comprises:
when the remaining battery of each of the plurality of aircraft is greater than the battery energy to be consumed, determining the aircraft with a highest remaining battery as the target aircraft;
wherein the target aircraft comprises a solar panel; the communication method further comprises:
obtaining a location coordinate of the target aircraft;
obtaining a standard time of a time zone corresponding to the location coordinate of the target aircraft;
determining an optimal energy absorption azimuth angle of the target aircraft according to the standard time and the location coordinate of the target aircraft; wherein when an angle between a light energy absorption surface of the solar panel and a horizontal plane is equal to the optimal energy absorption azimuth angle, the light energy absorption efficiency of the solar panel is highest;
determining a target azimuth angle based on the optimal energy-absorbing azimuth angle of the target aircraft; and
adjusting the angle between the light energy absorption surface of the solar panel and the horizontal plane to the target azimuth angle.

10. A communication device based on 5G and Wi-Fi 6, comprising:
at least one processor; and
a memory communicated with the at least one processor;
wherein the memory stores instructions executed by the at least one processor to cause the at least one processor to execute the communication method in claim 1.
